(19) United States
(12) Patent Application Publication
(10) Pub. No.: US 2021/0158045 A1
(43) Pub. Date: May 27, 2021

(54) IMAGE MARKUPS

(71) Applicant: Hewlett-Packard Development Company, L.P., Spring, TX (US)

(72) Inventors: Ian N. Robinson, Palo Alto, CA (US); Mithra Vankipuram, Palo Alto, CA (US); Ji Won Jun, Palo Alto, CA (US); Mary G. Baker, Palo Alto, CA (US)

(73) Assignee: Hewlett-Packard Development Company, L.P., Spring, TX (US)

(21) Appl. No.: 17/045,798

(22) PCT Filed: Jun. 22, 2018
(86) PCT No.: PCT/US2018/039057

§ 371 Date: Oct. 7, 2020

(51) Int. Cl. G06K 9/00; G06T 19/00; G06T 11/60

(52) U.S. Cl. CPC G06K 9/00671; G06T 11/60; G06T 19/006

(57) ABSTRACT

In one example, a computing device for image markups can include a processing resource and a non-transitory memory resource storing instructions executable by the processing resource to: convert an image from a first format to a second format, display the image in the second format to receive a markup, and convert the markup from the image in the second format to the image in the first format based on location information of the image in the first format.

### BACKGROUND

Head mounted virtual reality (VR) devices and/or augmented reality (AR) devices may be used to provide an altered reality to a user. VR devices and AR devices may include displays to provide an altered reality experience to the user by providing video, images, and/or other visual stimuli to the user via the displays. VR devices and AR devices may include audio output devices to provide audible stimuli to the user to further the altered reality experienced by the user.

### BRIEF DESCRIPTION OF THE DRAWINGS

FIG. 1 illustrates an example system for generating image markups consistent with the present disclosure.

FIG. 2 illustrates an example memory resource for generating image markups consistent with the present disclosure.

FIG. 3 illustrates an example method for generating image markups consistent with the present disclosure.

FIG. 4 illustrates an example method for generating image markups consistent with the present disclosure.

FIG. 5 illustrates an example method for generating image markups consistent with the present disclosure.

### DETAILED DESCRIPTION

Virtual reality (VR) and/or augmented reality (AR) devices can be utilized to provide an altered reality scene for a user. As used herein, an altered reality scene can include a computer generated image positioned in a user's point of view. For example, an altered reality scene can include a virtual reality scene generated by a VR device and/or augmented reality scene generated by an AR device. In some examples, a first group of users can utilize the altered reality scene to perform a number of tasks and a second group of users may not have access to the altered reality scene. In these examples, the first group of users can capture images within the altered reality scene and provide the captured images to the second group of users for providing image markups. The second group of users can utilize the captured images without altered reality devices such as VR devices or AR devices to add the image markups. In these examples, the image markups can include text, drawings, and/or other images implemented into or over the captured images. In these examples, the image markups can be converted from the captured images into or on to the altered realty scene. In this way, the second group of users can utilize a non-altered reality format while the first group of users can view the image markups from the second group through the altered reality scene.

A number of systems and devices for image markups are described herein. In some examples, a computing device for image markups can include a processing resource and a non-transitory memory resource storing instructions executable by the processing resource to: convert an image from a first format to a second format, display the image in the second format to receive a markup, and convert the markup from the image in the second format to the image in the first format based on location information of the image in the first format.

In some examples, the systems and devices for image markups can utilize location data or meta data from the image capture process within the altered reality to generate images in a non-altered reality format that allow users without altered reality devices to implement image markups into the altered reality. In some examples, the meta data can be utilized to implement the image markups into the altered reality such that a user in the same location as the viewpoint for captured image can view the image markups. In this way, users without access to the altered reality can provide comments and/or feedback about the altered reality.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

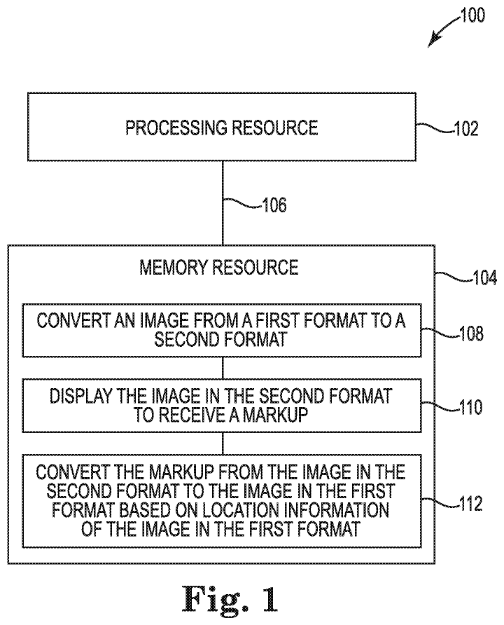

FIG. 1 illustrates an example system 100 for generating image markups consistent with the present disclosure. In some examples, the system 100 can be a computing device that can be utilized for generating image markups. For example, the system 100 can be utilized to receive markups from a non-altered reality format and implement the markups into an altered reality scene. As used herein, an altered reality scene can be a particular data file that can be executed to generate a corresponding image and/or a particular physical location with a particular data file to generate a corresponding image.

As illustrated in FIG. 1, the system 100 may comprise a processing resource 102 and a memory resource 104 storing machine-readable instructions to cause the processing resource 102 to perform an operation relating to generating image markups. As used herein, a memory resource 104 can be a non-transitory machine-readable storage medium. Although the following descriptions refer to an individual memory resource 104, the descriptions may also apply to a system with multiple processing resources and multiple machine-readable storage mediums. In such examples, the instructions may be distributed across multiple machine-readable storage mediums and the instructions may be distributed across multiple processing resources. Put another way, the instructions may be stored across multiple machine-readable storage mediums and executed across multiple processing resources, such as in a distributed computing environment.

In some examples, the memory resource 104 can be coupled to a processing resource 102 via a connection 106. A processing resource 102 may be a central processing unit (CPU), microprocessor, and/or other hardware device suitable for retrieval and execution of instructions stored in the memory resource 104. In some examples, a processing resource 102 may receive, determine, and send instructions through the connection 106. As an alternative or in addition to retrieving and executing instructions, a processing resource 102 may include an electronic circuit comprising an electronic component for performing the operations of the instructions in the memory resource 104. With respect to the executable instruction representations or boxes described and shown herein, it should be understood that part or all of the executable instructions and/or electronic circuits included within one box may be included in a different box shown in the figures or in a different box not shown.

Memory resource 104 may be any electronic, magnetic, optical, or other physical storage device that stores executable instructions. Thus, memory resource 104 may be, for example, Random Access Memory (RAM), an Electrically-Erasable Programmable Read-Only Memory (EEPROM), a storage drive, an optical disc, and the like. The executable instructions may be “installed” on the memory resource 104. Memory resource 104 may be a portable, external or remote storage medium, for example, that allows a system that includes the memory resource 104 to download the instructions from the portable/external/remote storage medium. In this situation, the executable instructions may be part of an “installation package”. As described herein, memory resource 104 may be encoded with executable instructions related to generating image markups.

The system 100 may include instructions 108 stored in the memory resource 104 and executable by a processing resource 102 to convert an image from a first format to a second format. In some examples, the first format can be an altered reality format that can be utilized by a device such as a VR device and/or an AR device. For example, the first format can be a file that can be utilized by the VR device or AR device to generate an altered reality scene that can include a plurality of locations visible through the VR device or AR device.

In some examples, the image in the first format can be generated by a VR device or an AR device. For example, the VR device or AR device can have a particular scene or file loaded to generate a corresponding altered reality scene. In this example, the image in the first format can be images generated at particular locations within the altered reality scene. As used herein, capturing an image such as a screen shot, still image, or video can include generating an image of an area of the altered reality scene that is being displayed by the VR device and/or AR device.

In some examples, the particular location in the first format generated by the VR device or AR device can include location data associated with the particular location. For example, the images in the first format can include location data that can include information relating to the position or location of the features of the image within the altered reality scene. In this example, the location data relating to the position or location can include a size or area of the image, a coordinate position of a user within the altered reality scene, an orientation of the user at the coordinate position, and/or other information that can be utilized to identify the location of the user within the altered reality scene. The location data can also include a pointer to the scene in the first format. As used herein, pointer can be an icon that can be selected to bring a user utilizing a VR device and/or AR device to the location where the image is captured in the first format. For example, the pointer can include a link or filename. In some examples, when the image in the first format is captured and converted into an image in the second format, the location data can be captured as meta data attached to the image in the second format.

In some examples, the images within the altered reality scene in the first format can be viewed utilizing VR devices or AR devices by loading the corresponding file into the VR device or AR device. However, the first format may not be compatible with non-VR devices and/or non-AR devices. For example, a computing device that is not a VR device or AR device may not be able to open, execute, and/or display the images of the altered reality scene in the first format. In this way, a first user utilizing a VR device or AR device may not be able to share portions of the altered reality scene in the first format and send the portions of the altered reality scene in the first format to a second user that does not have access to a VR device and/or AR device. In some examples, the images in the first format can be converted to a second format that can be viewed by the second user with a computing device that is a non-VR device and/or non-AR device.

In some examples, a user can capture a still image or video within the altered reality scene. In some examples, converting the image from the first format to the second format can include capturing the still image or video. In some examples, capturing the still image or video can include capturing the location data associated with the altered reality scene at the location where the still image or video was captured and storing the location data as meta data. For example, a VR device or AR device can display a particular area or particular image within an altered reality scene. In this example, a still image or video can be captured of the particular area or particular image. In this example, the location data associated with the particular area or particular image can be captured and stored as meta data with the still image or video. In some examples, the image in the second format may capture a smaller field of view of the altered reality scene than that rendered by the altered reality application. Information describing the field of view of the image in the second format can be included in the image's meta data.

In some examples, the image in the second format can be a non-altered reality image that can be utilized or viewed by non-VR devices and/or non-AR devices. For example, the image in the second format can be utilized by a mobile computing device such as a laptop computer. As used herein, a non-altered reality image can include a computer generated image that is displayable on a user interface of a non-VR device or non-AR device and/or a computer generated image that is not formatted for a VR device or AR device. In some examples, the generated image in the second format can include the meta data from the location data of the image in the first format. In some examples, markups provided on the image in the second format can be converted or overlaid onto the image in the first format by utilizing the location data from the captured image in the first format.

The system 100 may include instructions 110 stored in the memory resource 104 and executable by a processing resource 102 to display the image in the second format to receive a markup. As described herein, the image in the second format can be opened and/or displayed by a computing device that is a non-VR device and/or a non-AR device. For example, the image in the second format can be displayed on a monitor or display of a computing device. In some examples, the image in the second format can be displayed with an application that enables image markups to be implemented into or on the image in the second format. For example, the application can be instructions or a computing program that can be utilized to generate text, shapes, and/or other images on an image like the image in the second format. In some examples, the first format can be a three dimensional format and the second format can be a two dimensional format. That is, the first format can be an altered reality format that include three dimensions and the second format can be a non-altered reality format with two dimensions.

In some examples, the application can be opened on the computing device that is a non-VR and/or non-AR device. In these examples, the application can be utilized to open and display the image in the second format. In this way, the application can be utilized to display the image in the second format to receive the image markups. As used herein, the image markups can include digital images that are added to a displayed image. For example, the image markups can include, but are not limited to: text boxes, shapes, clip art, ink strokes from a digital pen, photo images, and/or other types of images.

The system 100 may include instructions 112 stored in the memory resource 104 and executable by a processing resource 102 to convert the markup from the image in the second format to the image in the first format based on location information of the image in the first format. In some examples, converting the markup from the image in the second format to the image in the first format can include separating the markup from the image in the second format. For example, the markup portion of the image in the second format can be removed and utilized to generate a markup overlay. As used herein, a markup overlay can include the markup portion of the image in the second format without the image. That is, a new data file can be generated that includes only the markup portion without the image. In some examples, the markup overlay can include the location data from the image in the first format. For example, the new data file that is generated to store the markup portion can also include the location data from the image in the first format stored as meta data in the second format.

In some examples, the location data from the image in the first format can be utilized to generate meta data stored with the image in the second format for the markup portion. For example, the markup portion of the image in the second format can be positioned at a particular location of the image in the first format. In this example, the location data from the image in the first format can be stored as meta data with the image in second format and utilized to determine a location of the markup portion for the image in the first format. In this example, meta data can be generated and stored with the markup as a new data file. In other examples, the location data from the image in the first format can be stored with the markup portion as a new data file and when the markup is to be implemented into the image in the first format, the location data from the image in the first format can be utilized to determine a location for the markup. As described herein, the location data and/or meta data can include field of view information for a viewpoint of a user when converting the image from the first format to the second format. That is, the location data and/or meta data can include the field of view for a user capturing an image within the altered reality scene.

In some examples, the meta data can be the location data for the image in the first format. For example, the location data or location information can include coordinate information for a viewpoint utilized to generate the image from the first format. In some examples, the location information can be utilized to determine a location and view direction within the altered reality scene to overlay the markup. For example, the markup can be implemented into the altered reality scene at a location corresponding to the location and view direction where the user captured the image in within the first format. In this way, a VR device and/or AR device can be utilized to view the markup in the altered reality scene.

In some examples, the system 100 can include instructions to position an overlay of the markup on the image in the first format based on the location information. For example, the image in the first format can include the location of the objects within the image at a particular location within the altered reality. In some examples, the markup can be implemented into the altered reality scene at a location corresponding to the location of the captured image within the first format. For example, the location data or meta data associated with the captured image in the second format can be utilized to determine a corresponding location for the markup to be implemented. In this example, the markup can be displayed when a user utilizing the altered reality scene is in the location when the image was captured so that the frame of view in the altered reality scene aligns with the markup overlaid at the location.

In some examples, the markup on the image in the first format can be visible from a range of locations within the altered reality scene and/or visible from a range of user orientations within the altered reality scene. For example, a user within the altered reality scene can view the markup within a range of distances from the original location the image was captured in the second format. In addition, the user within the altered reality scene can view the markup within a range of degrees of the orientation of the original location the image was captured in the second format. In some examples, the range of distances and/or range of degrees can be based on application preferences. For example, the range of distances and range of degrees can be altered based on user preferences, an application utilized to view the altered reality scene, predetermined settings for the altered reality scene, and/or a position of objects in the altered reality scene.

In some examples, overlaying the markup at the correct location can ensure that the location of the markups are at the same location when the image was viewed in the second format. For example, the markup can be positioned within the first format such that a user positioned at the same location as the user capturing the image in the second format can view the markups in a corresponding location. In this example, the viewpoint location information stored in the meta data of the image in the second format can be utilized to transport a virtual user to the location of the user that captured the image in the second format. In this way, a virtual user can view the image in the first format from the same or similar viewpoint as the user that captured the original image. This can allow a markup to point out or identify particular elements within the image in the second format and the same particular elements can be pointed out or identified in the altered realty scene.

For example, the image in the first format can include a triangle and a square. In this example, the markup from the image in the second format can include an arrow that points to the square. In this example, the markup can be overlaid into the altered reality scene such that, when viewed from the viewpoint used for capturing the image in the second format, the arrow is pointing at the square. If the location data or meta data is not utilized to overlay the markup, the same arrow could point away from the square or potentially point toward the triangle. In addition, if the markup is positioned in the scene correctly, but not viewed from the same viewpoint or field of view, the same arrow could point away from the square. In this example, the message of the markup may be miscommunicated if or when the markup in the altered reality scene does not correspond to the location from which the image was captured in the second format. To prevent this type of miscommunication, a user may be teleported to the correct view location captured in the meta data of the markup image, when the image is selected.

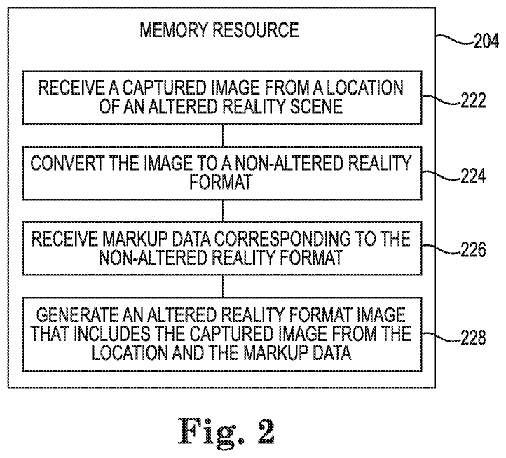

FIG. 2 illustrates an example memory resource 204 for generating image markups consistent with the present disclosure. As used herein, a memory resource 204 can be a non-transitory machine-readable storage medium. In some examples, the memory resource 204 can be coupled to a processing resource via a connection. The connection can be an electrical or communicative connection to allow communication between the processing resource and the memory resource 204. A processing resource may be a central processing unit (CPU), microprocessor, and/or other hardware device suitable for retrieval and execution of instructions stored in the memory resource 204.

The memory resource 204 can include instructions 222 that can be executable by a processing resource to receive a captured image from a location of an altered reality scene. As described herein, a VR device and/or an AR device can be utilized to capture images within an altered reality scene. For example, a VR device and/or AR device can display an altered reality scene from a data file. In this example, a particular area or portion of the altered reality scene can be captured and stored as a separate data file. In this example, the separate data file can include a snapshot or video of a portion of the altered reality scene that can be opened by a VR device or AR device to display the snapshot or video of the portion of the altered reality scene. In some examples, the captured image can be in a three dimensional format that can provide the same or similar experience when opened by a VR device or AR device as when the image was captured within the altered reality scene.

In some examples, the captured image can be received from a VR device or an AR device that captured the image within the altered reality scene. For example, a first user can utilize a VR device or an AR device to capture a portion of the altered reality scene. In this example, the captured image can be sent to a computing device coupled to the memory resource 204. In this example, the captured image can be sent to a user with a computing device that is not a VR device or an AR device. Thus, a computing device that is not a VR device or an AR device can receive the captured image in an altered reality format. In some examples, the altered reality format can be a three dimensional image that can be displayed with a VR device or an AR device.

The memory resource 204 can include instructions 224 that can be executable by a processing resource to convert the image to a non-altered reality format. In some examples, the captured image within the altered reality format can be converted to a non-altered reality format. In some examples, the altered reality format can be a three dimensional format and the non-altered reality format can be a two dimensional format. That is, converting the image from an altered reality format to a non-altered reality format can include making alterations to the image such that the image can be displayed in a two dimensional format.

The memory resource 204 can include instructions 226 that can be executable by a processing resource to receive markup data corresponding to the non-altered reality format. In some examples, receiving markup data can include receiving inputs through a computing device to add or delete images within a display of the image in the non-altered reality format. For example, the image in the non-altered reality format can be displayed on a monitor or display of a computing device. In this example, the markup data can include images such as text, drawings, clipart, and/or other types of images that are utilized to alter the displayed image. In this example, the peripheral devices such as a keyboard or mouse can be utilized to add or delete the images within the displayed image in the non-altered reality format.

As described herein, VR devices and/or AR devices may not be accessible to all users of a group of users. In some examples, the memory resource 204 can provide instructions that allow a first user to provide an image in an altered reality format to a second user that does not have access to a VR device or an AR device. In these examples, the second user can still view the image by converting the image from an altered reality format to a non-altered reality format to provide feedback or comments with markups as described herein.

The memory resource 204 can include instructions 228 that can be executable by a processing resource to generate an altered reality format image that includes the captured image from the location and the markup data. In some examples, generating an altered reality format image can include updating an altered reality scene to include the markup data. For example, the captured altered reality image can be captured from within an altered reality scene that was displayed through a VR device and/or an AR device. In this example, generating an altered reality format image can include overlaying the markup data on the captured altered reality image based on the meta data and/or location information within the meta data. In this example, the markup data can be displayed to a user in the altered reality scene by placing them in the same location that was used to capture the image. Thus, a user utilizing a VR device or AR device can view the markups from a non-altered reality format within the altered reality scene.

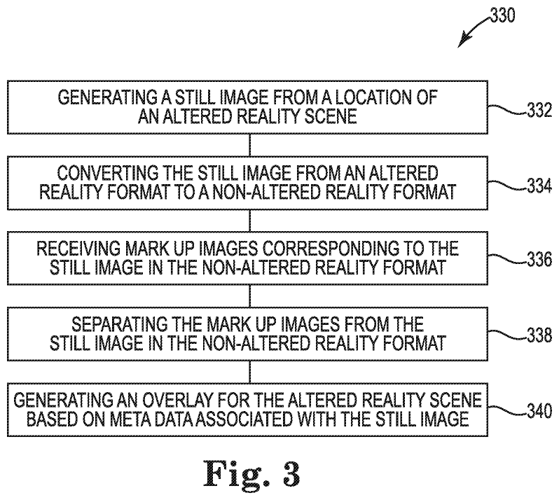

FIG. 3 illustrates an example method 330 for generating image markups consistent with the present disclosure. In some examples, the method 330 can be performed by a system and/or computing device as described herein. For example, the method 330 can be instructions stored on a memory resource and executed by a processing resource to perform the method 330.

At 332, the method 330 can include generating a still image from a location of an altered reality scene. In some examples generating a still image from a location of an altered reality scene can include utilizing a capturing device of a VR device and/or an AR device to capture a photographic like image of a portion of the altered reality scene. For example, a VR device and/or AR device can be utilized to navigate through an altered reality scene.

In some examples, a still image, video, or photograph can be captured within the altered reality scene at a particular location within the altered reality scene. In these examples, the still image, video, and/or photograph can be captured with meta data that describes the location, area captured in the image, and/or other data that can be utilized to identify the viewpoint of the captured image within the altered reality scene.

In some examples, the meta data captured with the image in the altered reality scene can include a coordinate location of the virtual user (e.g., position of user within the altered reality scene). In some examples, the meta data can include directional information of the captured image at the coordinate location. For example, the directional information can include a coordinate direction that a virtual user is facing when capturing the image within the altered reality scene. In this example, the coordinate direction can be expressed as rotations about the three coordinate axes, or as yaw, pitch and roll.

At 334, the method 330 can include converting the still image from an altered reality format to a non-altered reality format. In some examples, converting the still image from an altered reality format to a non-altered reality format can include utilizing location parameters of the viewpoint used to capture the still image in the altered reality format to generate meta data which is attached to the still image in the non-altered reality format. In some examples, the meta data of the still image in the converted non-altered reality format can be maintained through editing operations such as a markup. In some examples, the maintained meta data can be utilized to identify a location within the altered reality scene for implementing markup images provided on the non-altered reality format image.

At 336, the method 330 can include receiving markup images corresponding to the still image in the non-altered reality format. In some examples, the still image in the non-altered reality format can be displayed on a computing device that does not have VR or AR capabilities. For example, the image in the non-altered reality format can be displayed on a monitor or display of a computing device such as a laptop or desktop computer. In some examples, the image in the non-altered reality format can be displayed utilizing an editing application that can alter the appearance of an image. For example, the editing application can be utilized to display the image in the non-altered reality format and allow edits to the image.

In some examples, the editing application can allow a user with a computing device to insert images, delete portions of the image, and/or manipulate the view of the image in the non-altered reality format. In some examples, the edits that are provided within the editing application can be considered markup images. For example, the markup images can include, but are not limited to: inserted or deleted text boxes, inserted or deleted shapes, inserted or deleted images, and/or alterations to the image that change the appearance of the image.

At 338, the method 330 can include separating the markup images from the still image in the non-altered reality format. In some examples, separating the markup images from the still image can include identifying edits and corresponding locations made within an editing application. For example, each of a plurality of edits or markup images can be identified with a corresponding location or placement on the still image in the non-altered reality format. In this example, the plurality of edits or markup images can be separated from the still image in the non-altered reality format while maintaining the image meta data from 334.

At 340, the method 330 can include generating an overlay for the altered reality scene based on the meta data associated with the still image. In some examples, generating the overlay for the altered reality scene can include generating a document with a clear background that includes the markup images at a location defined by the meta data in the non-altered reality format. Selecting the markup causes the user's viewpoint to move to the same location and direction as the original capture, stored in the image meta data. The markup document with the clear background is positioned and scaled to fill the field of view also stored in the meta data. In this way, the markup image provided on the non-altered reality format can be positioned at a corresponding location of the altered reality format. In some examples, applying the overlay to the altered reality scene can include applying the overlay such that the overlay is viewable at the location, orientation, and field of view of the user utilizing the VR device or AR device to capture the still image.

In some examples, the method 330 can include applying an authentication technique for viewing the overlay at the location of the altered reality scene. For example, the authentication technique can include prompting an authentication method when a user attempts to access or view the overlay at the location of the altered reality scene. In some examples, the authentication technique can be utilized to identify a user and determine whether the identified user is authorized to view the overlay at the location of the altered reality scene. For example, a user can be prompted to provide a user name and password combination to view the overlay at the location of the altered reality scene.

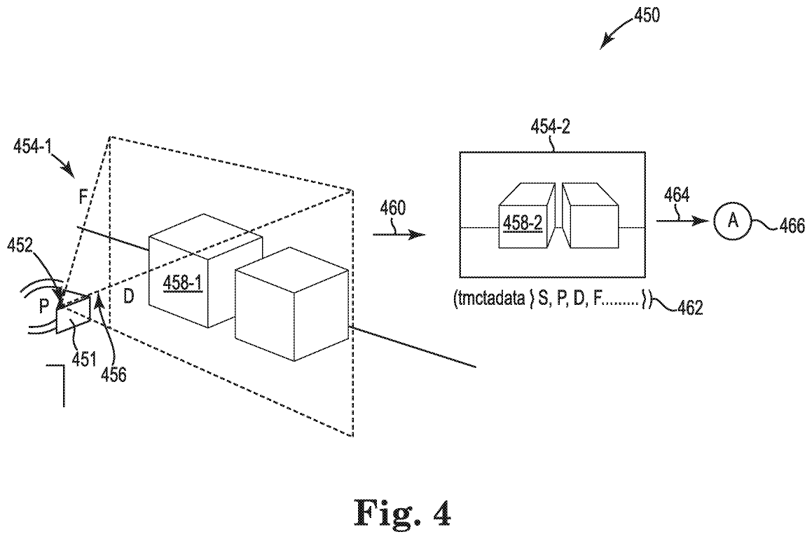

FIG. 4 illustrates an example method 450 for generating image markups consistent with the present disclosure. FIG. 4 illustrates a method 450 that can include capturing an image frame 454-1 within an altered reality scene in an altered reality format and converting the image frame 454-1 into an image frame 454-2 in a non-altered reality format. In some examples, a VR device 451 can be utilized to view the image frame 454-1 in an altered reality scene. As described herein, an altered reality scene can be an environment that is loaded on the VR device 451. In some examples, the altered reality scene can be a three dimensional environment that can be explored with the VR device 451. The method 450 describes utilizing a VR device 451, however an AR device can be utilized in place of the VR device 451 to perform the method 450.

In some examples, the VR device 451 can include an image capturing device or application that can be utilized to capture image frames such as image frame 454-1. In some examples, the image capturing device or application can capture still images, panoramic images, and/or video images of a particular object or portion of the altered reality scene. For example, the VR device 451 can capture a portion of the altered reality scene that includes object 458-1.

In some examples, the image capturing device or application can be utilized to capture the image frame 454-1 and corresponding meta data 462. As described herein, the meta data 462 can include coordinate information and/or location information for the viewpoint (P) 452 and the view direction (D) 456. In some examples, the meta data 462 can include the size and/or dimensions of the image frame 454-1. For example, the meta data 462 can include a height and width of the image frame 454-1 within the altered reality scene.

In some examples, the method 450 can include converting the image frame 454-1 in the altered reality format to the image frame 454-2 in the non-altered reality format. In some examples, the image frame 454-1 may be utilized by VR devices and/or AR devices like VR device 451, but may not be utilized by non-VR devices or non-AR devices. Similarly, the image frame 454-2 in the non-altered reality format may be utilized by non-VR devices or non-AR devices, but may not be utilized by the VR device 451. In some examples, a first user may want to capture the image frame 454-1 and request markup images from a second user that may not have access to a VR device or AR device such as VR device 451. In these examples converting the image frame 454-1 to the image frame 454-2 at 460 can allow the second user to view the image frame 454-2 without utilizing a VR device or AR device.

In some examples, at 460 the method 450 can include utilizing the meta data 462 to convert the image frame 454-1 to image frame 454-2 such that the object 458-2 is presented in a similar way as object 458-1. For example, the field of view (F) can include similar proportions of the object 458-2 as represented by object 458-1 in the image frame 454-1. That is, the image frame 454-2 can include the same or similar objects and surrounding area to represent a similar point of view as the image frame 454-1. In some examples, the image frame 454-2 can maintain the same or similar meta data 462 as the image frame 454-1. In this way, the image frame 454-2 can be converted back to image frame 454-1.

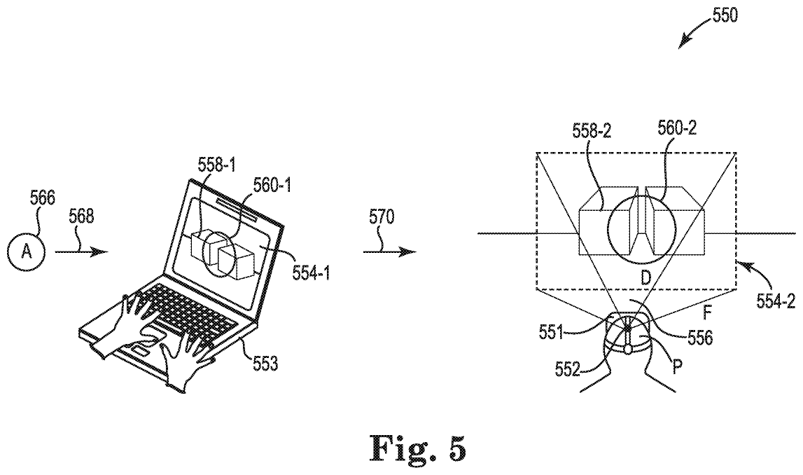

In some examples, at 464 the method 450 can include sending or transmitting the image frame 454-2 to a different user. In some examples, the image frame 454-2 can be sent or transmitted to a user that does not have access to a VR device or AR device like the VR device 451. In some examples, the method 450 can end at 466. In some examples the method 450 can be continued through method 550 as illustrated in FIG. 5.

FIG. 5 illustrates an example method 550 for generating image markups consistent with the present disclosure. Figure illustrates a method 550 for applying markup images 560-1 on an image frame 554-1 and applying the markup images 560-1 into the image frame 554-2. In some examples, the method 550 can begin at 566. As described herein, the method 550 can continue from method 450 as illustrated in FIG. 4.

In some examples, at 568 the image frame 554-1 can be received from a VR device and/or AR device. For example, the VR device and/or AR device can be utilized to convert a first image in an altered reality format to a second image in a non-altered reality format. In this example, the first image and the second image can represent the same or similar portion of an altered reality scene. In this example, the VR device and/or AR device can send or transmit the second image to a computing device 553 that is not a VR device or AR device (e.g., via email). In some examples, the computing device 553 can be a desktop computer, laptop computer, smart phone, and/or other type of computer that is not a VR device or AR device.

In some examples, the computing device 553 can receive and display the image frame 554-1. For example, the computing device 553 can include a display or monitor to display images. In this example, the computing device 553 can display the image frame 554-1 on the monitor or display. In some examples, the computing device 553 can utilize an application to open and display the image frame 554-1. In some examples, the computing device 553 can utilize an editing application to generate markup images 560 on the displayed image frame 554-1. For example, the editing application can be utilized to display the image frame 554-1 and allow the markup images 560 to be added to the displayed image frame 554-1. In some examples, the markup images 560 can include text boxes, shapes, arrows, deletions, and/or other images that can be added or removed from the displayed image frame 554-1.

In some examples, the computing device 553 can be utilized to communicate a message through the markup images 560-1 added to the displayed image frame 554-1. For example, the displayed image frame 554-1 can be an image of a device that is malfunctioning. In this example, the markup images 560-1 can be feedback from a technician for fixing the malfunctioning device. In this example, the markup images 560-1 can include an arrow to identify a part of the device that may be causing the malfunction and a text box that describes how to fix or replace the part of the device. In this example, the location of the arrow on the image frame 554-1 can be converted to a corresponding position on the image frame 554-2 such that the arrow is pointing to the correct part of the device. In this way, a user utilizing the computing device 553 can provide feedback or markup images 560-1 on the image frame 554-1 that can be converted to the image frame 554-2 as markup images 560-2.

In some examples, at 570 the method 550 can include applying the markup images 560-1 from a second format image to a first format image. For example, the method 550 can include separating the markup images 560-1 from the image frame 554-1. In this example, the meta data (e.g., meta data 462 as referenced in FIG. 4) can be utilized to determine location data for view location 552 and the placement and scaling of the marked-up frame 554-2 to match the field of view (F).

In some examples, the separated markup images 560-1 can be utilized to generate an overlay that can be added to the image frame 554-2 to selectively display or selectively remove from the image frame 554-2. For example, the separated markup images 560-2 can be added as an overlay (e.g., markup images 560-2 without a background to block other objects within the image frame 554-2) of the image frame 554-2 when an option to view the markup images 560-2 is selected. In this example, the option can be a selectable option for a user utilizing the VR device 551. As used herein, a selectable option can be an icon or image that when selected can apply the markup images 560-2 over the image frame 554-2 and when deselected can remove the markup images 560-2. In this way, a user utilizing the VR device 551 can remove the markup images 560-2 to view objects behind the markup images 560-2. The markup image and the original image can be overlaid in the user's view with user-selectable levels of transparency.

As described herein, the markup images 560-2 can be an overlay that can position the markup images 560-2 a corresponding location to markup images 560-1. In some examples, the location of the markup images 560-2 of the overlay can be based on the meta data and/or location data. In some examples, the selectable option to view the markup images 560-2 within the altered reality scene can be indicated to a user utilizing a VR device or AR device such as VR device 551 using icons (e.g., flags) placed at the captured viewpoints in the altered reality scene. In some examples, selecting the icon or flag can move the user to the position (P) 552, which can be the same or similar position as position (P) 452 as referenced in FIG. 4. For example, the position (P) 552 can be a position where a virtual user within the altered reality scene captured an image that was utilized for implementing the markup images 560-1. In some examples, the overlay that includes the markup images 560-2 can be encrypted with an authentication technique. As used herein, an authentication technique can be a way to protect data by authenticating a user. For example, the markup images 560-2 may only be viewable when a user name and password combination is provided upon selecting the selectable option. In this way, authorized and unauthorized users can utilize the same altered reality scene without risking an unauthorized user accessing or viewing the markup images 560-2.

The above specification, examples and data provide a description of the method and applications, and use of the system and method of the present disclosure. Since many examples can be made without departing from the scope of the system and method of the present disclosure, this specification merely sets forth some of the many possible example configurations and implementations.

What is claimed:

1. A computing device, comprising:
a processing resource; and
a non-transitory memory resource storing instructions executable by the processing resource to:
convert an image from a first format to a second format;
display the image in the second format to receive a markup; and
convert the markup from the image in the second format to the image in the first format based on location information of the image in the first format.

2. The computing device of claim 1, wherein the first format is a captured image from an altered reality scene and the second format is a non-altered reality format.

3. The computing device of claim 2, wherein the first format includes location information for the captured image within the altered reality scene.

4. The computing device of claim 3, wherein the instructions to convert the image from the second format to the first format include instructions to position an overlay of the markup on the image in the first format based on the location information.

5. The computing device of claim 1, wherein the first format is a three dimensional format and the second format is a two dimensional format.

6. A non-transitory memory resource having stored thereon machine readable instructions to cause a computer processing resource to:
receive a captured image from a location of an altered reality scene;
convert the image to a non-altered reality format;
receive markup data corresponding to the non-altered reality format; and
generate an altered reality format image that includes the captured image from the location and the markup data.

7. The medium of claim 6, comprising instructions to update the altered reality scene with the altered reality format image based on the location of the captured image.

8. The medium of claim 7, wherein the altered reality scene includes the markup data overlaid at the location of the captured image.

9. The medium of claim 6, wherein the captured image includes meta data that defines the location of the image and a location of a user when capturing the image.

10. The medium of claim 9, wherein the meta data of the capture image is utilized to update the location of the altered reality scene when the location of the image is viewed from a perspective of the location of the user when capturing the image.

11. The medium of claim 6, wherein the altered reality scene is a location specific altered reality scene.

12. A method for generating image markups, comprising:
generating a still image from a location of an altered reality scene;
converting the still image from an altered reality format to a non-altered reality format;
receiving markup images corresponding to the still image in the non-altered reality format;
separating the markup images from the still image in the non-altered reality format; and
generating an overlay for the altered reality scene based on meta data associated with the still image.

13. The method of claim 12, wherein the meta data includes the location, an orientation, and a field of view when generating the still image.

14. The method of claim 13, wherein generating the overlay includes applying the overlay to the altered reality scene such that the overlay is viewable at the location, orientation, and field of view.

15. The method of claim 12, comprising applying an authentication technique for viewing the overlay at the location of the altered reality scene.
